(19) United States
(12) Patent Application Publication
(10) Pub. No.: US 2008/0216600 A1
(43) Pub. Date: Sep. 11, 2008

(54) Hub controller

(76) Inventors: Ching-Ting Chen, Sinjhuang City (TW); Chi-Lung Yang, Sinjhuang City (TW)

Correspondence Address: BACON & THOMAS, PLLC, 625 SLATERS LANE, FOURTH FLOOR, ALEXANDRIA, VA, 22314-1176, US

(21) Appl. No.: 12/003,804

(22) Filed: Jan. 2, 2008

(30) Foreign Application Priority Data
Mar. 6, 2007 (TW) 096203666

(51) Int. Cl. B23Q 16/06

(52) U.S. Cl. 74/813 R

(57) ABSTRACT

The present invention relates to a kind of hub controller structure, wherein the ring flange stopping on the surface of the sleeve that could enable the axis without loosening off with the axial sleeve during rotation process; and the lateral slot at the center of the base part of the sleeve could enable the positioning point of the axis to press against the axial sleeve to form positioning function; and again with the two ends of the ring flange stopping as limit position stopping the axis and the position limiting ends on both sides of the connecting part could generate specific angle limiting effect on the axial sleeve during rotation.

### FIELD OF THE INVENTION

The present invention relates to a kind of hub controller, and more particularly to a hub mechanism that, by assembling the axis and the axial sleeve, is used for positioning without slipping and could form limiting position at a certain angle during rotation.

### BACKGROUND OF THE INVENTION

The prior art of the structure of the hub controller is used as the media for the device that requires opening and closing actions. Its structure is an axial sleeve with cavity space and an axis installed in the said cavity space of the axis. The said axis can rotate to the left or to the right in the center of the axial sleeve. One side of the said axis is installed with a connecting part; the said connecting part can be assembled with other objects. User makes use of his hand to wrench away the said other objects, enabling the said connecting part to carry the said axis synchronously and generates the above stated rotation in the cavity space of the said axial sleeve.

However, such kind of design has drawback in that the rotation stated above to the hub controller is actually a kind of repetitive rotating action. Once the device is used for too long or the user mistakenly applies excessive force the said axis often will gradually loosen outwards from the original center of the cavity space or worse even could break off completely from the said cavity space, rendering the rest of the parts assembled with the said connecting part to fall off or be damaged. There is no doubt such serious flaw in use calls for improvement.

### SUMMARY OF THE INVENTION

Therefore, to resolve the problem of prior art stated above the inventor attempts to improve the hub controller by installing a base part on the surface of the sleeve and a corresponding ring flange stopping such that when the axis is rotating in the axial sleeve it would not loosen from the said axial sleeve causing the axis to slip off.

Also, between the ring flange stopping stated above and the base part a flat surface is formed; a limiting stop exist between the said flat surface and the ring flange stopping; through the axial body and the two limiting sides of the connecting parts pressing against the limiting stop of the axial sleeve stated above the axis rotating to the left or to the right in the axial sleeve can be generated, achieving specific angle limiting effect.

In addition, a lateral slot is installed between the cavity space stated above and the base part so that the positioning point could cause the axis to be positioned on the axial sleeve when pressed against the lateral slot.

The technical means adopted in this invention is in the ring flange stopping installed on the surface of the sleeve causing the axis and the axial sleeve will not slip off; and with the lateral slot at the center of the base part of the sleeve the axis could be positioned on the axial sleeve; and with the two ends of the ring flange stopping as the limiting stops the axis could generate “limiting position” function of specific angle while rotating.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is the 3D illustration of the assembly of the axial sleeve and axis of the present invention;

FIG. 2 is the 3D illustration of the axis of the present invention;

FIG. 3 is the 3D illustration of the axial sleeve of the present invention;

FIG. 4 is the top view based on FIG. 3;

FIG. 5 schematically shows the axis rotating action of the present invention;

FIG. 6 schematically shows yet another illustration of the axial rotating action of the present invention;

FIG. 7 is the top view of the cross-sectional illustration based on FIG. 1; and

FIG. 8 is the top view of the cross-sectional illustration based on FIG. 6.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings, wherein

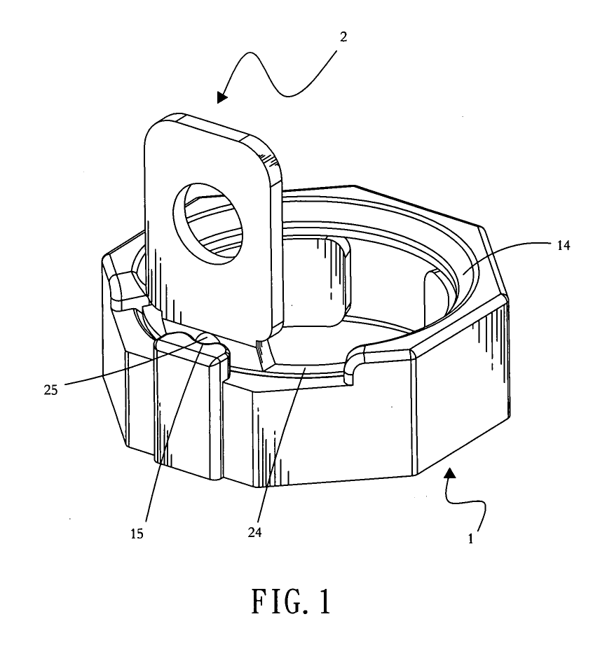

FIG. 1 is a 3D diagram of the assembly of the axial sleeve (1) and axis (2) of the first embodiment of the present invention;

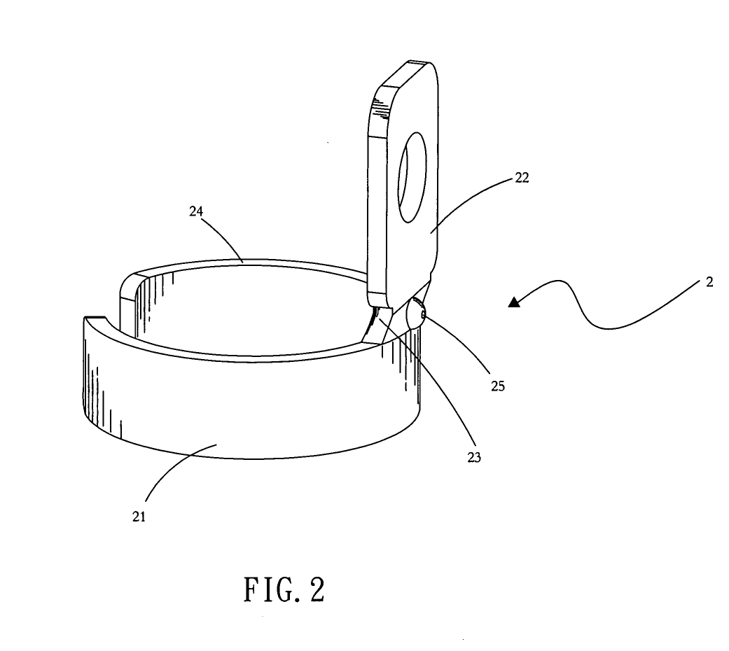

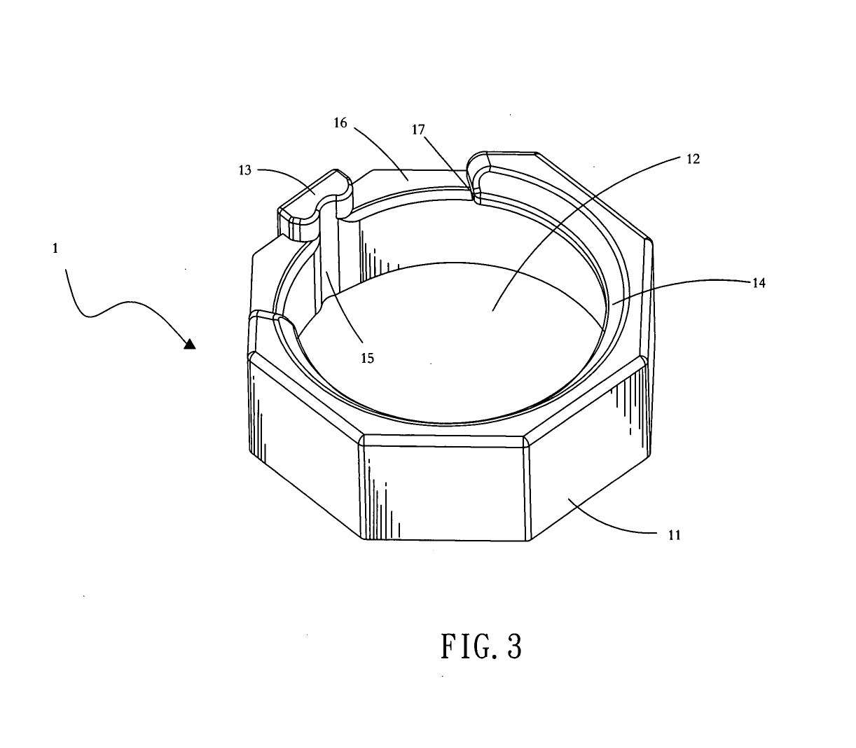

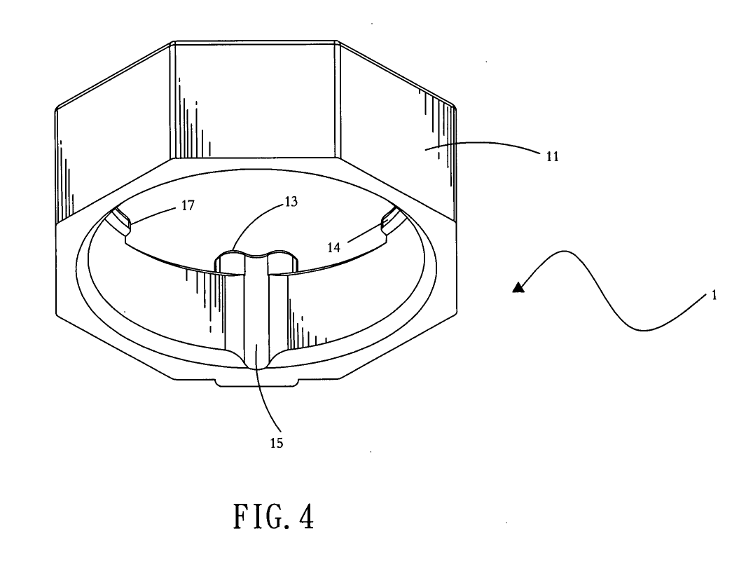

Please refer to FIG. 2, FIG. 3, and FIG. 4. The present invention includes an axial sleeve (1); within the sleeve (11) a cavity space (12) is installed; the surface is installed with a base part (13) and a corresponding ring flange stopping (14); between the said cavity space (12) and the said base part (13) a lateral slot (15) is installed; between the said ring flange stopping (14) and the above stated base part (13) a flat surface (16) is formed; between the said flat surface (16) and the ring flange stopping (14) a position limiting stop (17) is formed; and an axis (2), wherein the axial body (21) is installed in the cavity space (12) of the sleeve (11), one side of the said axial body (21) has an extended connecting part (22), on both sides of the said connecting part (22) are installed with a position limiting end (23), between one surface of the said axial body (21) and the above stated position limiting end (23) is a flat surface (24).

The Said position-limiting end (23) could press against a position-limiting stop (17) of the above stated axial sleeve (1);

Between the said position-limiting ends (23) a positioning point (25) corresponding to the above stated lateral slot (15) is formed;

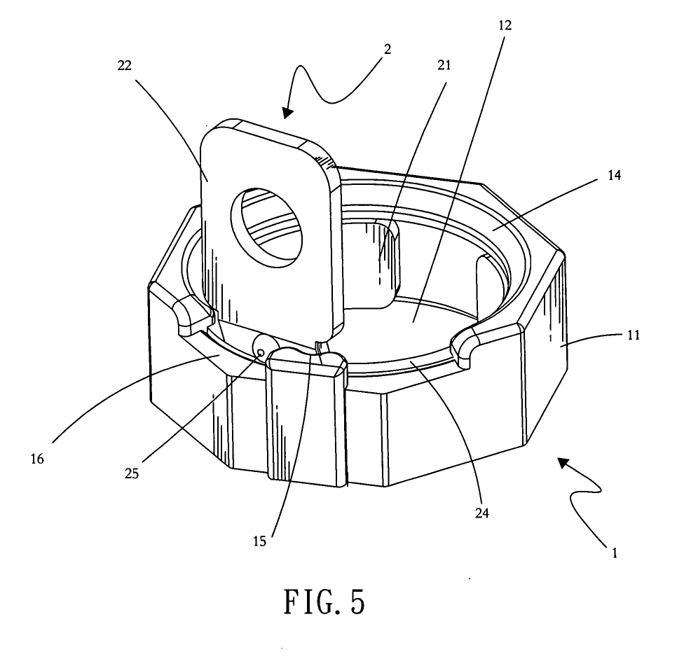

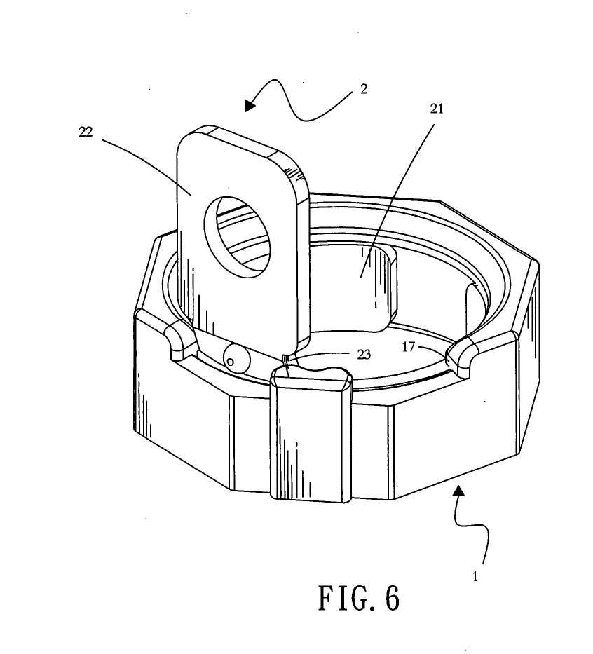

Through the assembly of the structure stated above, please refer to FIG. 1, FIG. 5, and FIG. 6. FIG. 1 schematically shows the axial sleeve (1) and the axis (2) is showing the most primitive positioning state, the positioning point (25) is pressed against in the lateral slot (15), the flat surface (24) is also located at the lower position of the ring flange stopping (14); in FIG. 5 when user slightly rotates the connecting part (22) in order for the axial body (21) to enable the cavity space (12) in the sleeve (11) to rotate synchronously the said positioning point (25) has already left the said lateral slot (15) and locates on the flat surface (16), resulting in the axis (2) would not slip off from the axial sleeve (1) during rotation due to loosening; in FIG. 6 when user again increase the rotation of connecting part (22) to greater angle the position limiting ends (23) of the two sides of the connecting parts (22) of the said axial body (21) can be pressed against the location limiting stop (17) of the axial sleeve (1) (either rotating left or rotating right are the same), resulting in the axis (2) in the axial sleeve (1) being set at a special angle limit without the worry of excessive rotation while at the same time could maintain the result of axis (2) and axial sleeve (1) stated above not loosening.

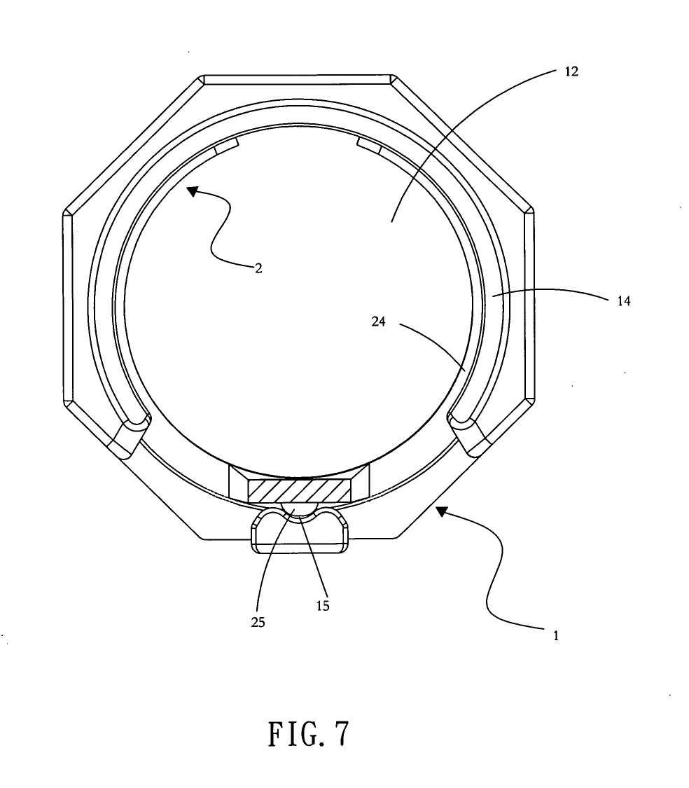

FIG. 7 schematically shows the top view of FIG. 1. From the illustration it can be understood that the above stated flat surface (24) is covered under the ring flange stopping (14) such that the said ring flange stopping (14) forms a shielding alike action, causing the axis (2) always stays in the cavity space (12). Therefore, the said axis (2) could achieve the effect of “not slipping off the said axial sleeve (1) and drop off” during rotation or stationary process; meanwhile the said axis (2) and the said axial sleeve (1) are in stationary state before formation of rotation. At this time the said positioning point (25) is pressing against the said lateral slot (15), i.e. in forming the function of “axis (2) could be positioned in the said axial sleeve (1)”;

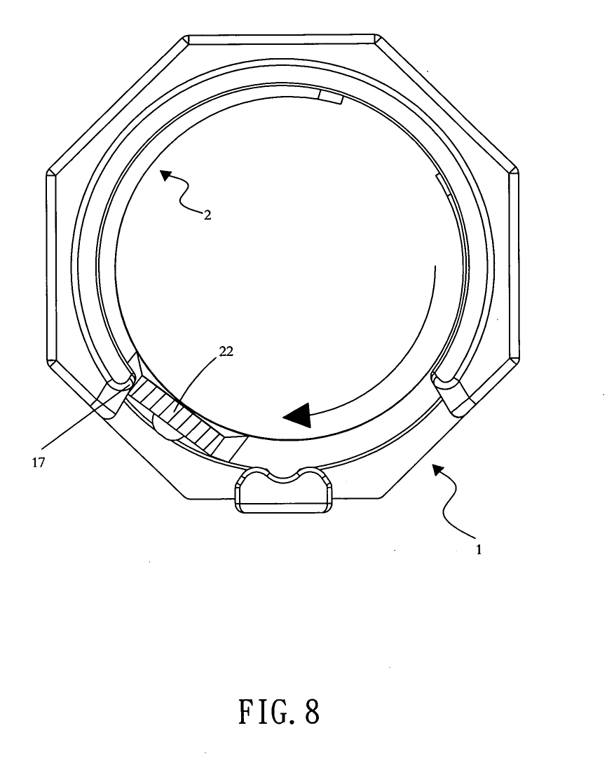

FIG. 8 schematically shows the top view of FIG. 6. From the illustration it is easy to understand that when the user rotates the connecting part (22) of the above stated axis (2) to the left (clockwise direction) to the maximum angle the function of the “axis (2) in the axial sleeve (1) is set to a specific angle without having to worry about excessive rotation” can be achieved. For the same reasoning, rotating the connecting part (22) of the said axis (2) to the right (counterclockwise direction) is having the same effect stated above.

Though this invention has already explained in detail using the above stated embodiment, such explanation is however for the user mastering the art to better understand the present invention and by no means limited to the range of this embodiment.

In summary, all shapes, structures, features or equalizing changes and modification based on such spirit shall all apply to this patent application.

What is claimed is:

1. A kind of hub controller comprising an axial sleeve, a cavity space is installed in the sleeve; an base part and a corresponding ring flange stopping are installed on the surface; and an axis which uses the cavity space installed in the sleeve of the axial body where one surface of the axial body has extended a connecting part.

2. The hub controller as stated in claim 1, wherein between the ring flange stopping of said sleeve and the above stated base part forms a flat surface. Between the said flat surface and the ring flange stopping a limit position stopping and the two sides of the said connecting part of the axis are each installed with a limit position end, between one side of the said axial body and the above stated limit positing end is the flat surface, where the said limit position end can be pressed against the limit position stopping of the above axial sleeve.

3. The hub controller as, stated in claim 1, wherein between the said cavity space of the sleeve and the said base part is installed with a lateral slot, between the said limit position ends of the axis the positioning point corresponding to the above stated lateral slot is formed.
